(19) United States
(12) Patent Application Publication
(10) Pub. No.: US 2013/0166828 A1
(43) Pub. Date: Jun. 27, 2013

(54) DATA UPDATE APPARATUS AND METHOD FOR FLASH MEMORY FILE SYSTEM

(71) Applicant: Electronics and Telecommunications Research Institute, Daejeon (KR)

(72) Inventor: Han-Sung CHUN, Daejeon (KR)

(73) Assignee: Electronics and Telecommunications Research Institute, Daejeon (KR)

(21) Appl. No.: 13/726,880

(22) Filed: Dec. 26, 2012

(30) Foreign Application Priority Data
Dec. 27, 2011 (KR) 10-2011-0143195

(51) Int. Cl. G06F 12/02

(52) U.S. Cl. CPC G06F 12/0253; G06F 12/0246
USPC 711/103; 711/170

(57) ABSTRACT

Disclosed herein are a data update apparatus and method. The apparatus includes an update identification unit, a data storage unit, a block allocation unit, and a data update unit. The update identification unit determines whether the input/output request signal corresponds to an update signal. The data storage unit stores mapping information about the blocks of an arbitrary file in a metadata area. The block allocation unit stores addresses of one or more free blocks, which are selected from among blocks included in the data storage unit and in which data has not been stored. The data update unit acquires the addresses of the free blocks, writes the update data to the free blocks, and updates existing block addresses, which belong to information included in mapping information of the data storage unit and to which the update data has been mapped, with the addresses of the free blocks.

### CROSS REFERENCE TO RELATED APPLICATION

This application claims the benefit of Korean Patent Application No. 10-2011-0143195, filed on Dec. 27, 2011, which is hereby incorporated by reference in its entirety into this application.

### BACKGROUND OF THE INVENTION

1. Technical Field

The present invention relates to a data update apparatus and method for storing data in the file system of flash memory, used as a storage device for data, which are capable of improving the operating speed and durability of the flash memory when the file system processes the update of data.

2. Description of the Related Art

Flash memory is widely used as a storage device in a variety of embedded systems because the cost thereof is low, the power consumption thereof is low, and the size thereof is small.

In particular, NAND flash memory, which is flash memory of a type being widely used, includes many erase blocks, and each of the erase blocks includes many pages. Furthermore, in the case of large block NAND flash memory whose use is increasing recently, the size of a single page is 2 KB, and 64 pages constitute a single erase block.

Three operations, that is, read, write and erase operations, may be performed on flash memory. Each of the read and write operations is performed on a page basis, and the write operation may require the erase operation. In order to write data to a page to which has been written once, all erase blocks to which the page belongs should be first erased. The erase operation requires a longer time than the read/write operation. Furthermore, since each erase block has a limitation to the number of erases, the corresponding erase block cannot be used any more when the number of erases reaches a limit. Erase blocks which cannot be used any more correspond to bad blocks. Accordingly, when wear-leveling which enables erase blocks to be uniformly used is performed, the sufficient lifespan of flash memory can be secured.

That is, flash memory has the problem of requiring a long processing time when data is written to an area to which data has been written once and the problem of being unable to use the blocks of flash memory when they reach a limit because the blocks are worn by use. Accordingly, a method of processing data by performing specific operations using a file system corresponding to the higher layer of flash memory was proposed to overcome the above problems.

That is, different solutions were presented for a method of using flash memory itself as a storage device and for a method of implementing a Flash Translation Layer (FTL) using hardware and using it as an FTL device (an eMMC, a SD card, or the like) combined with flash memory, respectively.

That is, when flash memory itself is directly used as a storage device, a log-structured file system is widely used. That is, for example, a journaling flash file system (JFFS2) or a yet another flash file system (YAFFS2) may be used. Log-structured file system-type file systems consider a storage space to be a log and write data to the storage space sequentially from the front thereof. Furthermore, data, together with metadata, is stored, and a mapping table is constructed and managed on main memory on a metadata basis. However, since the overall area of flash memory should be read, metadata should be searched for and a mapping table should be constructed on memory when a file system is mounted, there arise the problem of requiring a long processing time and the problem of consuming much of main memory in order to maintain a mapping table.

Furthermore, in the case of the FTL device, software (an FTL layer) mounted on the device enables a higher OS (Operating System) to prevent the problems of the time delay and wear of flash memory. Accordingly, an existing disk file system may be used. For example, an ext2 file system which is widely used in Linux may be used.

Furthermore, existing disk file systems are mostly configured such that metadata is stored in the front area of a storage space and data is stored in the remaining space. These systems do not use much of main memory because the reading of preceding metadata is enough when mounting is performed and, therefore, a mounting time is short and also a data structure is simple.

However, when a data update occurs, an in-place update which performs a data update at an existing location is performed, and therefore this is disadvantageous to flash memory. Furthermore, when an in-place update occurs, a corresponding erase block of flash memory should be erased and changed data should be written at the location, or mapping conversion frequently occurs via an FTL layer, so that there arises the problem of affecting the lifespan and performance of the device.

### SUMMARY OF THE INVENTION

Accordingly, the present invention has been made keeping in mind the above problems occurring in the prior art, and an object of the present invention is to provide a data update apparatus and method for the file system of flash memory, which modify a method of processing the update of the disk file system of the flash memory, thereby preventing the flash memory from being worn or the writing speed from being lowered even when a data update occurs.

In order to accomplish the above object, the present invention provides a data update apparatus, including an update identification unit for, when an input/output request signal is received, determining whether the input/output request signal corresponds to an update signal; a data storage unit for storing mapping information about blocks of an arbitrary file in a metadata area separate from a data area; a block allocation unit for storing addresses of one or more free blocks, which are blocks which are selected from among blocks included in the data storage unit and in which data has not been stored; and a data update unit for, if the input/output request signal is an update signal, acquiring the addresses of the free blocks for writing an update data corresponding to the update signal via the block allocation unit, writing the update data to the free blocks corresponding to the acquired addresses, and updating existing block addresses, which belong to information included in mapping information of the data storage unit and to which the update data has been mapped, with the addresses of the free blocks to which the update data has been written.

In order to accomplish the above object, the present invention provides A data update method, including, when an input/output request signal is received, determining, an update identification unit, whether the input/output request signal corresponds to an update signal, and, if the input/output request signal is an update signal, receiving, by a data update unit, an update request; requesting information about addresses of one or more free blocks from a block allocation unit; acquiring the addresses of the free blocks, which belong to blocks included in a data storage unit for storing mapping information about blocks of an arbitrary file in a metadata area separate from a data area and which correspond to blocks in which data has not been stored, from the block allocation unit; and writing an update data corresponding to the update signal to the free blocks corresponding to the acquired addresses, and updating existing block addresses, which belong to the mapping information included in the data storage unit and to which the update data has been mapped, with the addresses of the free blocks to which the update data has been written.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the data structure of a file system according to an embodiment of the present invention;

FIG. 2 is a diagram showing the configuration of a data update apparatus according to an embodiment of the present invention;

FIG. 3 is a diagram showing the configuration of a data update apparatus according to another embodiment of the present invention;

FIG. 4 is a diagram showing a storage layer according to an embodiment of the present invention;

FIG. 5 is a diagram showing block matching according to an embodiment of the present invention;

FIG. 6 is a diagram showing the securing of free blocks according to an embodiment of the present invention;

FIG. 7 is a flowchart showing a data update method according to an embodiment of the present invention;

FIG. 8 is a detailed diagram showing the step of receiving an update request signal shown in FIG. 7; and

FIG. 9 is a detailed diagram showing the step of acquiring a free block address shown in FIG. 7.

### DESCRIPTION OF THE PREFERRED EMBODIMENTS

A variety of embodiments of the present invention will be described in detail with reference to the accompanying drawings. The terms “unit,” “module” and “device” which are used in the following description are used simply for ease of description, may be used interchangeably, and may be designed and implemented using hardware or software.

Furthermore, although embodiments of the present invention will be described in detail with reference to the accompanying drawings and the descriptions of the accompanying drawings, the present invention is not restricted or limited by the embodiment.

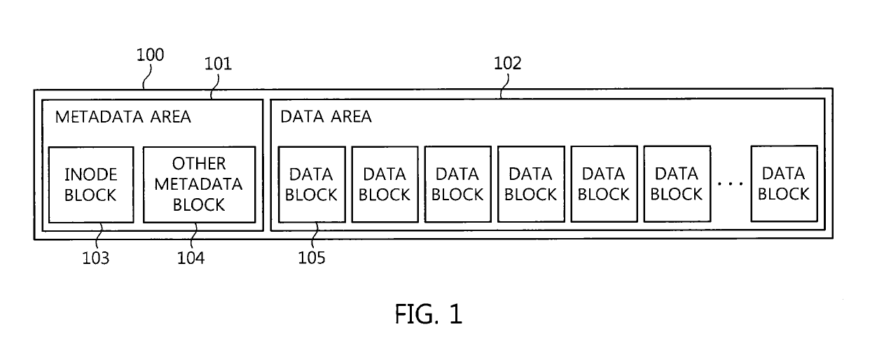

FIG. 1 is a diagram showing the data structure 100 of a file system according to an embodiment of the present invention.

In an embodiment, the data structure 100 of the file system may include an ext2 type structure, as shown in FIG. 1.

That is, the file system 100 according to the embodiment of the present invention divides a storage space into sections of uniform size such as 1 KB, 2 KB, 4 KB, or the like, and then manages them. Sections which have uniform size and which are managed by the file system 100 are referred to as blocks. That is, a storage space is considered to be a set of successive blocks.

Furthermore, a metadata area 101 may be fixed to a specific address area of a storage device. An inode list 103 which is distinguished from an other metadata block 104 may be separately included in the metadata area.

The other metadata block 104 may include a free block list and a free inode list.

That is, a data storage unit according to the embodiment of the present invention may include inode information, including the addresses of data blocks which belong to an arbitrary file, in the metadata area.

An inode corresponds to a single file. Furthermore, the inode may include the locations of the data blocks which belong to the corresponding file, that is, address information. Accordingly, when an I/O request (read or write request) signal is input, which data block is related to the signal is determined, and the address of the determined data block on a storage device may be acquired from an inode.

Accordingly, in accordance with a conventional data update method, when a write request signal related to the content of an existing file is input, a write is performed at an existing location. That is, an in-place update occurs, so that the wear of flash memory is accelerated and processing speed is lowered.

Accordingly, a data update apparatus according to an embodiment of the present invention changes addresses where the blocks of a file will be stored when an update occurs in order to prevent in-place update from occurring, thereby allowing an out-of-place update method to be used. Data update apparatuses and a data update method according to embodiments of the present invention will be described in detail below with reference to the drawings.

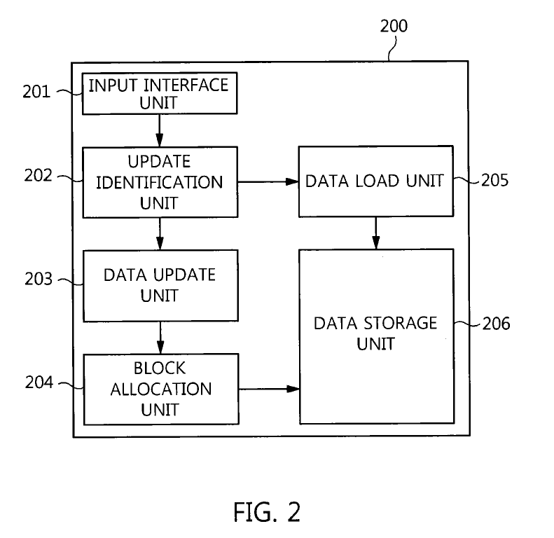

FIG. 2 is a diagram showing the configuration of the data update apparatus 200 according to an embodiment of the present invention.

The data update apparatus 200 according to this embodiment may include an input interface unit 201, an update identification unit 202, a data update unit 203, a block allocation unit 204, a data load unit 205, and a data storage unit 206.

The input interface unit 201 may receive an I/O request signal from a user or some other device. Furthermore, when the request signal is received, the input interface unit 201 may transmit the received signal to the update identification unit 202.

The update identification unit 202 may perform the operation of determining whether the I/O request signal entering a file system corresponds to an update request signal. That is, if the I/O request signal is not a read request signal but corresponds to a write request signal and a block at a location for which a write is requested was already allocated to a predetermined file and is being used, the I/O request signal may be identified as an update request signal. Accordingly, if the I/O request signal is identified as an update request signal, the data update unit 203 may be called. In contrast, if the I/O request signal corresponds to a read request signal, the data load unit 205 is called, so that the operation of reading data may be performed.

The data update unit 203 transmits a signal, requesting free blocks to which data will be written, to the block allocation unit 204. The free blocks may include a block to which a file is not currently allocated and which is not being used. That is, the block allocation unit 204 may include information about the addresses of one or more free blocks which belong to blocks included in the data storage unit 206 and in which data has not been stored. Furthermore, the block allocation unit 204 may allocate one or more blocks which are selected from among the blocks included in the data storage unit 206 and to which data will be written.

Accordingly, the data update unit 203 may acquire the addresses of blocks to which data will be written. That is, when an update signal is received, the data update unit 203 may acquire the addresses of one or more free blocks, to which update data corresponding to the update signal will be written, from the block allocation unit 203, writes the update data to free blocks which correspond to the acquired addresses, and change the addresses of one or more data blocks, which belong to the addresses of data blocks included in the inode information of the data storage unit, to the addresses of the free blocks to which the update data has been written.

That is, requested data is written to new blocks, and enters the addresses of blocks in an inode. Furthermore, as to the address part, the addresses of old blocks are discarded and changed to the addresses of newly received blocks, and old blocks may be released because they are not being used. That is, an addition to the free block list included in the other metadata block of FIG. 1 may be made.

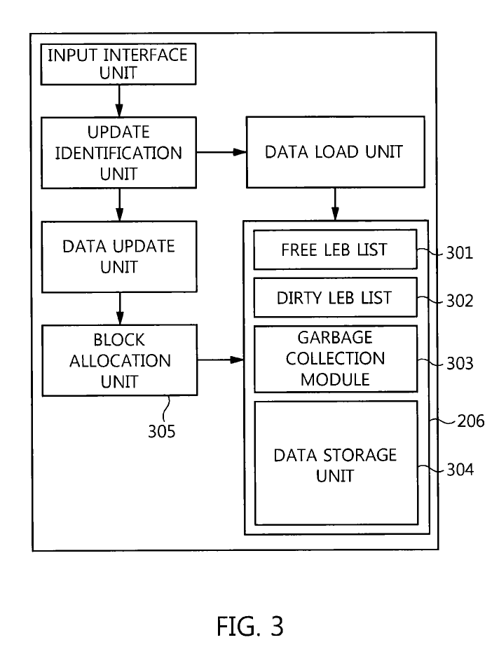

FIG. 3 is a diagram showing the configuration of a data update apparatus according to another embodiment of the present invention.

In accordance with this embodiment, a data storage device for using a data storage method according to an embodiment of the present invention in flash memory using a method in which flash memory itself, not an FTL device, is directly used as a storage device may further include a free LEB list 301, a dirty LEB list 302, and a garbage collection module 303, in addition to the configuration shown in FIG. 2.

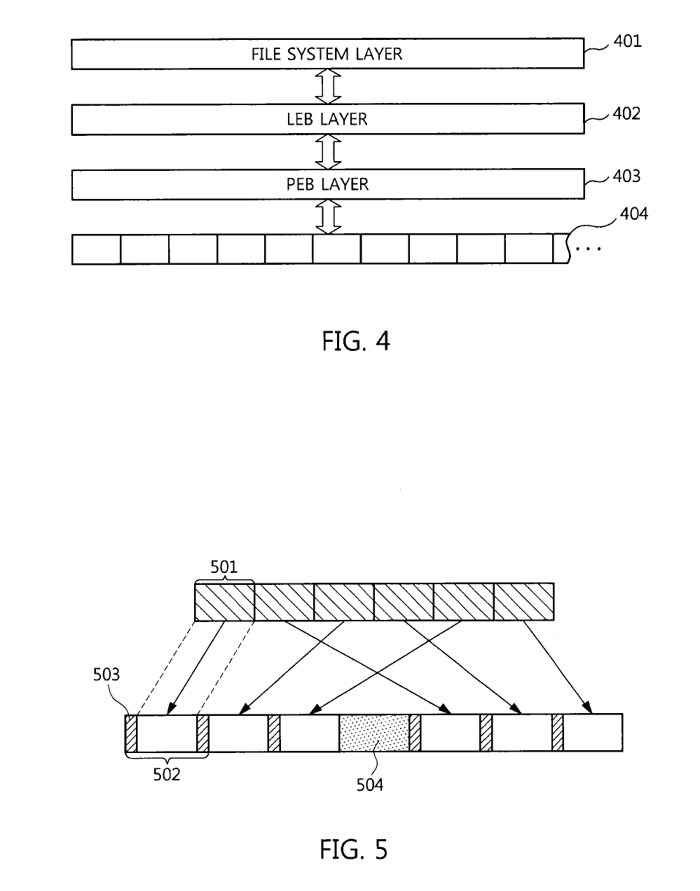

That is, the method in which flash memory itself is directly used as a storage device enables data update according to the present invention to be performed via a Logic Erase Block (LEB) layer and a Physical Erase Block (PEB) layer because there is no Flash Translation Layer (FTL) implemented using hardware. These layers will be described in detail with reference to FIGS. 4 and 5.

The free LEB list 301 is a list of LDBs within which there is no block which is being used. An LEB is a set of successive blocks, and may include, for example, 64 blocks. The number of blocks which constitute an LEB varies depending on the size of an erase block.

The block allocation unit 305 may perform an operation different from that of the block allocation unit 204 shown in FIG. 2. That is, the block allocation unit 305 provides free blocks when a call signal is received. For this purpose, one LEB may always be secured. The LEB may be retrieved from the free LEB list 301, and the LEB may be erased from the free LEB list 301. Furthermore, whenever a call is made, blocks may be provided sequentially from the first block of a previously prepared LEB. A provided block is erased from a free block list. When available blocks have been exhausted in the LEB, the corresponding LEB is added to the dirty LEB list 302. Furthermore, one LEB is retrieved from the free LEB list 301.

Furthermore, the block allocation unit 305 may be called in response to every write request signal. When there is no block for a file, the block allocation unit 305 may be naturally called. When there are one or more blocks, the block allocation unit 305 may be called in order to avoid an in-place update.

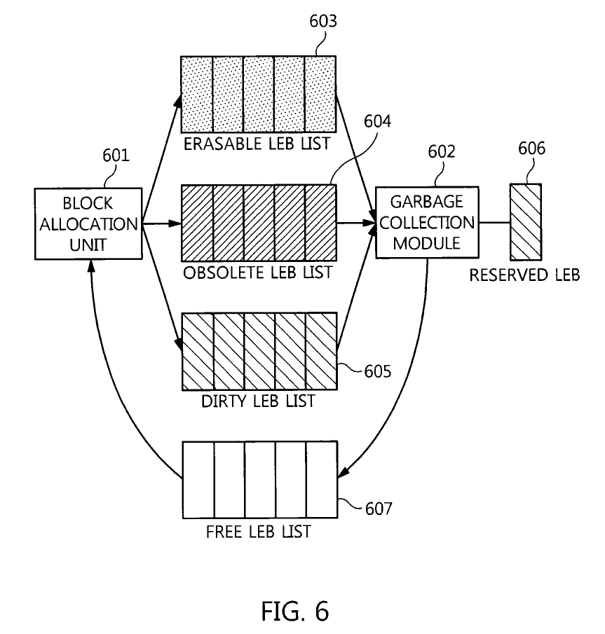

The garbage collection module 303 may secure one or more free LEBs by periodically checking the dirty LEB list 302 and performing garbage collection. The garbage collection will be described in detail with reference to FIG. 6.

FIG. 4 is a diagram showing a storage layer according to an embodiment of the present invention.

In order to perform data update according to the present invention, an LEB layer 402 which allows PEBs to be identified as LEBs may be used as the lower layer of the file system. That is, the LEB layer 402 may convert a PEB layer 403 including PEBs into LEBs, and may perform erase block-level wear-leveling by storing erase counters in the PEBs of the PEB layer 403.

Accordingly, physical flash memory may be accessed via the LEB layer 402 and the PEB layer 403 in response to a data read or write request signal from a file system layer 401.

That is, the LEB layer 402 may make the address of an LEB correspond to a PEB 404 of the flash memory. Accordingly, as shown in FIG. 4, the PEB layer 403 for enabling PEBs to be recognized on a PEB address basis may be included as a lower layer, or, in accordance with another embodiment, an LEB layer may be configured to also perform the functionality of the PEB layer 403.

Furthermore, when the data update apparatus according to the embodiment of the present invention is implemented using existing software installed on Linux, the file system may use ext2 software and the LEB layer 402 may use Unsorted Block Image (UBI) software. Furthermore, the PEB layer 403 may use Memory Technology Device (MTD) software.

FIG. 5 is a diagram showing block matching according to an embodiment of the present invention.

In accordance with this embodiment, even any PEB may be mapped to an LEB address. Furthermore, the LEB layer performs wear-leveling on an erase block basis.

Accordingly, a header 503 may be included in each PEB 502, and an LEB address and erase counter information may be stored in the header. For example, an erase counter may be stored in the first page of each PEB.

Accordingly, the file system above the LEB layer accesses an LEB address, and the LEB layer converts the LEB address into a PEB address and hands over the content of the corresponding PEB. Furthermore, when an in-place update occurs to an LEB, it may be possible to select a PEB with low consumption by referring to its erase counter and to map the PEB to an LEB. As a result, wear-leveling is performed via the LEB layer on an erase block basis, and therefore the consumption of only a specific PEB can be prevented even when a write is repeatedly requested from a specific LEB.

FIG. 6 is a diagram showing the securing of free blocks according to an embodiment of the present invention.

In accordance with this embodiment, NAND flash memory cannot write data to arbitrary page within an erase block, and should write data to pages sequentially from the first page thereof. Furthermore, if a write is made to a third page in an empty erase block, preceding first and second pages should be programmed in any manner.

Accordingly, in order to avoid such a problem, space management which is performed in conformity with the size of an erase block can improve efficiency.

Furthermore, when an out-of-place update is performed, the old data blocks of a file remain programmed in this flash memory. This portion is referred to as an obsolete area. That is, obsolete blocks are mixed with erase blocks.

Accordingly, in order to perform efficient block management, garbage collection may be performed. That is, since data, other than obsolete data, will be emigrated to other erase blocks and all remaining data will correspond to obsolete data when all of the data, other than obsolete data, will be emigrated, the corresponding erase blocks can be erased and prepared for a write.

Accordingly, in accordance with this embodiment of the present invention, the function of selecting one LEB, emigrating the effective data thereof to another LEB, erasing the existing LEB and transferring it to the free LEB list 607 may be performed.

That is, as shown in FIG. 6, a garbage collection module 602 may collect information from an erasable LEB list 603, an obsolete LEB list 604 where there is obsolete data, and a dirty LEB list 605, and perform a garbage collection operation by emigrating obsolete data to a reserved LEB 606, thereby updating a free LEB list 607.

Furthermore, the block allocation unit 607 may acquire information about free LEBs from the free LEB list, perform a data write operation, and update any one of the erasable LEB list 603, the obsolete LEB list 604 and the dirty LEB list 605.

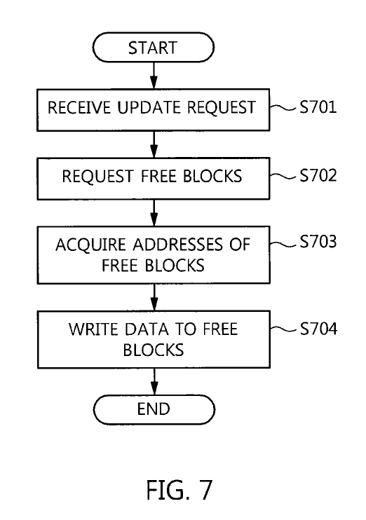

FIG. 7 is a flowchart showing a data update method according to an embodiment of the present invention.

In accordance with this embodiment, when an input/output request signal is received by the data update apparatus, the update identification unit 202 determines whether the input/output request signal corresponds to an update signal, and the data update unit 203 receives an update request if the input/output request signal is an update signal at step S701.

Thereafter, the data update unit 203 requests information about the addresses of free blocks from the block allocation unit 204 at step S702, and acquires the addresses of free blocks, which belong to blocks included in the data storage unit 206 for including inode information including the addresses of data blocks, belonging to an arbitrary file, in the metadata area, and which correspond to blocks in which no data has been stored, from the block allocation unit 204 at step S703.

Thereafter, update data corresponding to the update signal is written to free blocks corresponding to the acquired free block addresses, and the addresses of the data blocks which belong to the update data are changed to the addresses of the free blocks where the update data has been written, which belong to the addresses of the data blocks included in the inode information of the data storage unit 206 at step S704.

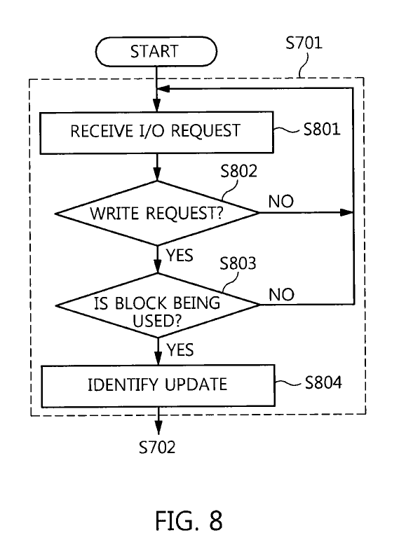

FIG. 8 is a detailed diagram showing the step of receiving an update request signal shown in FIG. 7.

In accordance with the embodiment, the step of receiving an update request signal shown in FIG. 7 may include the following steps.

First, when an input/output request signal is received by the data update apparatus at step S801, it is determined whether the input/output request signal is a write request signal at step S802, and it is determined whether a block at a location for which the write is requested was already allocated to a predetermined file and is being used if, as a result of the determination, it is determined that the input/output request signal is a write request signal at step S803.

That is, if the input/output request signal is a write request signal and the block at a location for which the write is requested was already allocated to a predetermined file and is being used, the input/output request signal may be identified as an update signal at step S804.

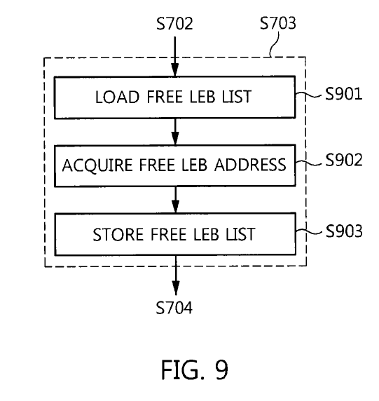

FIG. 9 is a detailed diagram showing the step of acquiring a free block address shown in FIG. 7.

In accordance with this embodiment, the step of acquiring a free block address shown in FIG. 7 may include the following steps.

First, when a free block request signal is received by the block allocation unit 204, blocks are allocated from an LEB that the block allocation unit 204 has, the free LEB list is loaded when the LEB that the block allocation unit 204 has does not have no more free block at step S901, and a free LEB address is acquired at step S902.

Furthermore, when the free LEB address is acquired, the acquired free LEB address is erased from the free LEB list and then this free LEB list is stored again at step S903.

That is, the block allocation unit 204 may receive a free block request signal, and a free LEB address may be newly allocated from the free LEB list when the request signal was received but no free block to be allocated remains in the LEB that the block allocation unit 204 has. Furthermore, the allocated free LEB address is erased from the free LEB list.

Furthermore, in accordance with this embodiment, when the block allocation unit 204 allocates blocks to the LEB corresponding to the acquired free LEB address and a write is performed on the blocks, the already described LEB layer can now connect a PEB to the corresponding LEB. Furthermore, in this case, the LEB layer may enable wear-leveling to be performed by connecting a PEB having the smallest counter value to the LEB while referring to the counter values of headers recorded in respective PEBs.

When the data update method according to the present invention is used, the problem of the flash memory being worn rapidly when a disk file system is applied to the flash memory can be greatly mitigated. Accordingly, the utilization of the disk file system in the flash memory can be improved, and the advantages of a short mounting time and low memory consumption can be achieved.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A data update apparatus, comprising:
an update identification unit for, when an input/output request signal is received, determining whether the input/output request signal corresponds to an update signal;
a data storage unit for storing mapping information about blocks of an arbitrary file in a metadata area separate from a data area;
a block allocation unit for storing addresses of one or more free blocks which are selected from among blocks included in the data storage unit and in which data has not been stored; and
a data update unit for, if the input/output request signal is an update signal, acquiring the addresses of the free blocks for writing an update data corresponding to the update signal via the block allocation unit, writing the update data to the free blocks corresponding to the acquired addresses, and updating existing block addresses, which belong to information included in mapping information of the data storage unit and to which the update data has been mapped, with the addresses of the free blocks to which the update data has been written.

2. The data update apparatus of claim 1, wherein:
the mapping information comprises:
inode information comprising addresses of the blocks of the arbitrary file;
a free LEB list comprising information about addresses of one or more Logic Erase Blocks (LEBs) which belong to LEBs matching one or more Physical Erase Blocks (PEBs) and to which data has not been written;
a dirty LEB list comprising information about an address of a Logic Erase Block (LEB) which belongs the LEBs and to which data has been written; and
a garbage collection module for performing a garbage collection operation while periodically checking the dirty LEB list, and
wherein the block allocation unit acquires information about an address of any one LEB which belongs to the information about addresses of LEBs included in the free LEB list, as the addresses of the free blocks.

3. The data update apparatus of claim 2, wherein the garbage collection module performs a garbage collection operation comprising an operation of securing a free LEB by emigrating data, other than obsolete data, from an arbitrary LEB to another LEB and erasing data corresponding to the obsolete data therefrom.

4. The data update apparatus of claim 2, wherein the block allocation unit, when the update data has been written to the free block via the data update unit, updates the addresses of the free blocks, the free LEB list, and the dirty LEB list.

5. The data update apparatus of claim 4, wherein the block allocation unit updates an address of an LEB, which belongs to the information about addresses of LEBs included in the free LEB list and which has a smallest erase counter value among erase counter values included in headers of the PEBs matching LEBs, with the addresses of the free blocks.

6. The data update apparatus of claim 1, wherein the update identification unit, if the input/output request signal is a write request signal and a block at a location for which the write has been requested was already allocated to a predetermined file and is being used, determines that the input/output request signal is an update signal.

7. The data update apparatus of claim 1, wherein the data storage unit stores data via a Flash Translation Layer (FTL).

8. The data update apparatus of claim 2, wherein the data storage unit is configured such that a physical area of flash memory is mapped to a PEB layer.

9. A data update method, comprising:
when an input/output request signal is received, determining, an update identification unit, whether the input/output request signal corresponds to an update signal, and, if the input/output request signal is an update signal, receiving, by a data update unit, an update request;
requesting information about addresses of one or more free blocks from a block allocation unit;
acquiring the addresses of the free blocks, which belong to blocks included in a data storage unit for storing mapping information about blocks of an arbitrary file in a metadata area separate from a data area and which correspond to blocks in which data has not been stored, from the block allocation unit; and
writing an update data corresponding to the update signal to the free blocks corresponding to the acquired addresses, and updating existing block addresses, which belong to the mapping information included in the data storage unit and to which the update data has been mapped, with the addresses of the free blocks to which the update data has been written.

10. The data update method of claim 9, wherein the requesting information about addresses of one or more free blocks from a block allocation unit comprises requesting the information about addresses of free blocks from a block allocation unit for including free LEB addresses of a free LEB list including information about addresses of LEBs, which belong to LEBs matching to one or more PEBs and to which data has not been written, as the information about addresses of free blocks

11. The data update method of claim 9, further comprising securing, by a garbage collection module, a free LEB by emigrating data, other than obsolete data, from an arbitrary LEB to another LEB and erasing data corresponding to the obsolete data therefrom.

12. The data update method of claim 10, further comprising, when the update data has been written to the free block via the data update unit, updating the addresses of the free blocks, the free LEB list, and a dirty LEB list.

13. The data update method of claim 12, wherein the updating comprises updating an address of an LEB, which belongs to the information about addresses of LEBs included in the free LEB list and which has a smallest erase counter value among erase counter values included in headers of the PEBs matching LEBs, with the addresses of the free blocks.

14. The data update method of claim 9, wherein the receiving an update request comprises, if the input/output request signal is a write request signal and a block at a location for which the write has been requested was already allocated to a predetermined file and is being used, determining that the input/output request signal is an update signal.
